(19) United States
(12) Patent Application Publication
(10) Pub. No.: US 2026/0186667 A1
(43) Pub. Date: Jul. 2, 2026

(54) STORAGE CONTROLLER, STORAGE SYSTEM AND OPERATING METHOD OF THE STORAGE CONTROLLER

(71) Applicant: Samsung Electronics Co., Ltd., Suwon-si (KR)

(72) Inventors: Kyung June Cho, Suwon-si (KR); Beom Sig Cho, Suwon-si (KR)

(21) Appl. No.: 19/259,826

(22) Filed: Jul. 3, 2025

(30) Foreign Application Priority Data
Dec. 30, 2024 (KR) 10-2024-0199968

(51) Int. Cl. G06F 3/06

(52) U.S. Cl. CPC G06F 3/0614; G06F 3/0655; G06F 3/0679

(57) ABSTRACT

A storage system includes a non-volatile memory device. The non-volatile memory device includes a plurality of memory blocks and a storage controller configured to access the non-volatile memory device using block addresses of the memory blocks. The storage controller is configured to receive a plurality of first reliability levels mapped to logical block addresses from the non-volatile memory device, map access frequency information included in dataset management information received from a host to a plurality of second reliability levels, update the plurality of first reliability levels to the plurality of second reliability levels based on logical block address range information of the dataset management information, and access, based on receiving an access command and an access address from the host, the non-volatile memory device by using a block address corresponding to one of the plurality of second reliability levels assigned based on the access address.

### CROSS-REFERENCE TO RELATED APPLICATION

This application claims priority from Korean Patent Application No. 10-2024-0199968 filed on Dec. 30, 2024, in the Korean Intellectual Property Office, and all the benefits accruing therefrom under 35 U.S.C. 119, the contents of which in its entirety are herein incorporated by reference.

### BACKGROUND

Semiconductor memory devices may be broadly classified into volatile memory and non-volatile memory. Volatile memory, such as DRAM or SRAM, has fast read and write speeds, but may lose stored data when power is disconnected. On the other hand, non-volatile memory may retain data even when power is no longer supplied.

Non-volatile memory includes ROM (Read Only Memory), PROM (Programmable ROM), EPROM (Electrically Programmable ROM), EEPROM (Electrically Erasable and Programmable ROM), flash memory, PRAM (Phase-change RAM), MRAM (Magnetic RAM), RRAM (Resistive RAM), and FRAM (Ferroelectric RAM).

### SUMMARY

As semiconductor manufacturing technology advances, memory devices are continuously increasing in integration density and capacity. The high integration of memory devices may have the advantage of reducing the manufacturing cost of memory devices. However, as memory devices become more integrated, the scale of memory devices decreases and their structure changes, various problems that have not been previously identified may be discovered. These newly discovered issues may damage the data stored in memory devices, thereby compromising their reliability. Consequently, there is a continuous demand for methods and devices to improve the reliability of memory devices.

The present disclosure provides a storage system that offers data with improved reliability based on dataset management information received from a host.

In general, in some aspects, the present disclosure provides a storage system comprising a non-volatile memory device including a plurality of memory blocks and a storage controller configured to access the non-volatile memory device using block addresses of the memory blocks, wherein the storage controller is configured to receive a plurality of first reliability levels mapped to logical block addresses from the non-volatile memory device, map access frequency information included in dataset management information received from a host to a plurality of second reliability levels, update the plurality of first reliability levels to the plurality of second reliability levels based on logical block address range information of the dataset management information and access the non-volatile memory device using a block address corresponding to one of the plurality of second reliability levels assigned based on the access address upon receiving an access command and an access address from the host.

In general, in some other aspects, the present disclosure provides A storage controller comprising a host interface configured to receive dataset management information including access frequency information and logical block address (LBA) range information from a host, a memory interface configured to access a non-volatile memory device using block addresses, a memory configured to store mapping information of a plurality of access frequency information, a plurality of reliability levels, and address information of the non-volatile memory device to each other and a control processing unit configured to access the non-volatile memory device in response to a command from the host, wherein the CPU is configured to receive an access command and an access address from the host, select the reliability level of the LBA range to which the access address belongs among a plurality of LBA range information, allocate a block address of the non-volatile memory device corresponding to the selected reliability level, and control the execution of the access command at the allocated block address of the non-volatile memory device.

In general, in some other aspects, the present disclosure provides a method of operating a storage controller comprises receiving reliability information for each memory block from a non-volatile memory device, receiving dataset management information including access frequency information and logical block address (LBA) range information from a host, configuring a mapping table for reliability level information mapped with the access frequency information, the LBA range information, and the reliability information, respectively, receiving an access command including an access address from the host, and allocating a memory block of the non-volatile memory device based on the reliability level information mapped to the LBA range information corresponding to the access address and accessing the allocated memory block.

The technical aspects of the present disclosure are not limited to those mentioned above, and other technical aspects which are not explicitly stated can be readily understood by those skilled in the art from the following description.

### BRIEF DESCRIPTION OF THE DRAWINGS

FIG. 1 is a block diagram illustrating an example of a storage system.

FIG. 2 is a block diagram illustrating an example of a storage controller.

FIG. 3 is a block diagram illustrating an example of a non-volatile memory device.

FIG. 4 shows an example of LBA range information included in dataset management information that is transmitted by a host.

FIG. 5 shows an example of access frequency information included in dataset management information that is transmitted by a host.

FIG. 6 is a mapping table that illustrates an example of mapping between access frequency information and modified reliability level.

FIG. 7 is a mapping table that illustrates an example of mapping between modified reliability level and LBA range information.

FIG. 8 is a mapping table that illustrates an example of mapping between reliability level and block address area of a non-volatile memory device.

FIGS. 9 and 10 are flow diagrams showing an example of an operation method of a storage system.

FIG. 11 is a diagram illustrating an example of a system in which a storage system is applied.

FIG. 12 is a diagram illustrating an example of a data center in which a memory device is applied.

### DETAILED DESCRIPTION

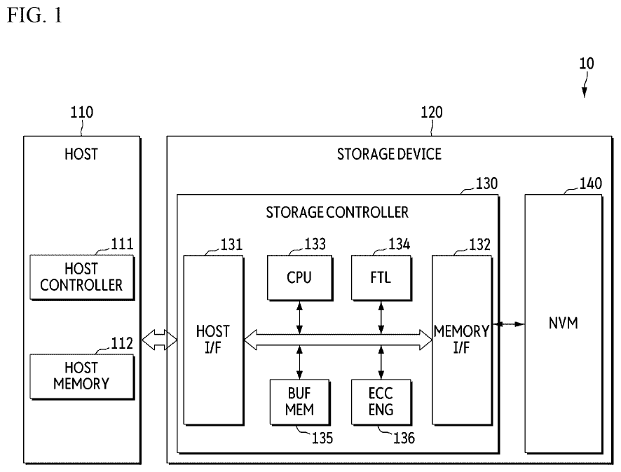

FIG. 1 is a block diagram illustrating an example of a storage system 10.

The storage system 10 can include a host 110 and a storage device 120. Additionally, the storage device 120 can include a storage controller 130 and a non-volatile memory (NVM) 140. In some examples, the host 110 can include a host controller 111 and host memory 121. The host memory 121 can function as a buffer memory that temporarily stores data to be transferred to the storage device 120 or data received from the storage device 120.

The storage device 120 can include storage media for storing data in response to requests from the host 110. For example, the storage device 120 can include at least one of an SSD (Solid State Drive), an embedded memory, or a removable external memory. If the storage device 120 is an SSD, it can comply with the NVMe (non-volatile memory express) standard. If the storage device 120 is an embedded memory or an external memory, it can comply with the UFS (universal flash storage) or eMMC (embedded multi-media card) standard. The host 110 and the storage device 120 can each generate and transmit packets according to the adopted standard protocol.

In some implementations, when the non-volatile memory device 140 in the storage device 120 includes flash memory, the flash memory can include a 2D NAND memory array or a 3D (or vertical) NAND (VNAND) memory array. As another example, the storage device 120 can include various other types of non-volatile memory. For example, the storage device 120 can employ Magnetic RAM (MRAM), Spin-Transfer Torque MRAM(STT-MRAM), Conductive bridging RAM (CBRAM), Ferroelectric RAM (FeRAM), Phase-change RAM (PRAM), Resistive RAM (RRAM), and various other types of memory.

In some implementations, the host controller 111 and the host memory 121 can be implemented as separate semiconductor chips. Alternatively, in some implementations, the host controller 111 and the host memory 121 can be integrated on the same semiconductor chip. For example, the host controller 111 can be one of several modules provided in an application processor, which can be implemented as a System on a Chip (SoC). Additionally, the host memory 121 can be an embedded memory within the application processor or an external non-volatile memory or a memory module located outside the application processor.

The host controller 111 can manage operations such as storing data (e.g., write data) from the buffer area of the host memory 121 in the non-volatile memory device 140, or storing data (e.g., read data) from the non-volatile memory device 140 in the buffer area.

The storage controller 130 can include a host interface 131, a memory interface 132, and a central processing unit (CPU) 133. Additionally, the storage controller 130 can further include a flash translation layer (FTL) 134, a buffer memory 135, and an error correction code (ECC) 136. The storage controller 130 can further include a working memory (not shown) into which the flash translation layer FTL 134 is loaded, and data access operations to the non-volatile memory device 140 can be controlled by the CPU 133 executing the flash translation layer 134.

The storage controller 130 can, for example, receive reliability information for each memory block from a non-volatile memory device, receive dataset management information including access frequency information and logical block address (LBA) range information from the host 110. The storage controller 130 can, for example, configure and store a mapping table for reliability level information that maps the access frequency information, the LBA range information, and the reliability information, respectively. When the storage controller 130 receives an access command from the host 110, it can allocate a memory block in the non-volatile memory device 140 based on the reliability level information mapped to the LBA range information to which the access address belongs. The storage controller can then access the allocated memory block.

The storage controller 130 can update the mapping table for the reliability level information whenever it receives the dataset management information.

The host interface 131 can send and receive packets to and from the host 110. The packets transmitted from the host 110 to the host interface 131 can include a command or data to be written to the non-volatile memory device 140, and the packets transmitted from the host interface 131 to the host 110 can include a response to a command or data retrieved from a non-volatile memory device 140. The memory interface 132 can transmit data to be written to the non-volatile memory device 140 to the non-volatile memory device 140, or it can receive data read from the non-volatile memory device 140. Such the memory interface 132 can be designed to comply with standard protocols such as Toggle or Open NAND Flash Interface (ONFI).

The flash translation layer 134 can perform various functions such as address mapping, wear-leveling, and garbage collection. The address mapping operation converts the logical address received from the host 110 to the physical address used to actually store data in the non-volatile memory device 140. The wear-leveling is an operation for preventing excessive deterioration of a specific block by ensuring that the blocks in a non-volatile memory device 140 are used uniformly. It can be implemented, for example, through firmware technology that balances the erasure counts of physical blocks. The garbage collection is an operation for securing available capacity in the non-volatile memory device 140 by copying valid data of a block to a new block and then erasing the old block.

The ECC engine 136 can perform error detection and error correction for read data read from the non-volatile memory device 140. More specifically, the ECC engine 136 can generate parity bits for write data to be written in the non-volatile memory device 140, and the parity bits generated in this way can be stored in the non-volatile memory device 140 along with the write data. When data is read from the non-volatile memory device 140, the ECC engine 136 can correct errors in the read data using the parity bits read from the non-volatile memory device 140 along with the read data, and output the corrected read data.

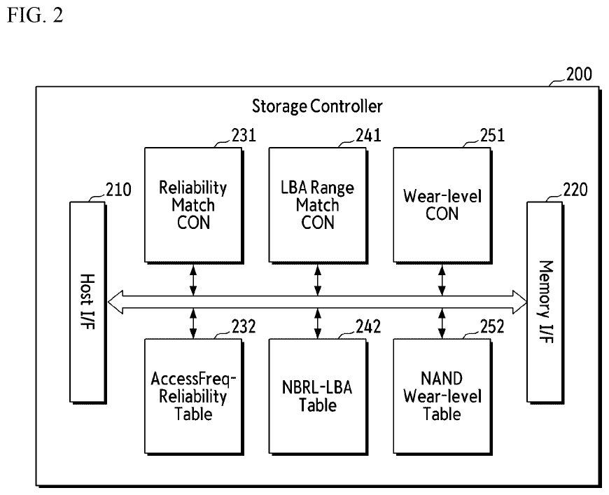

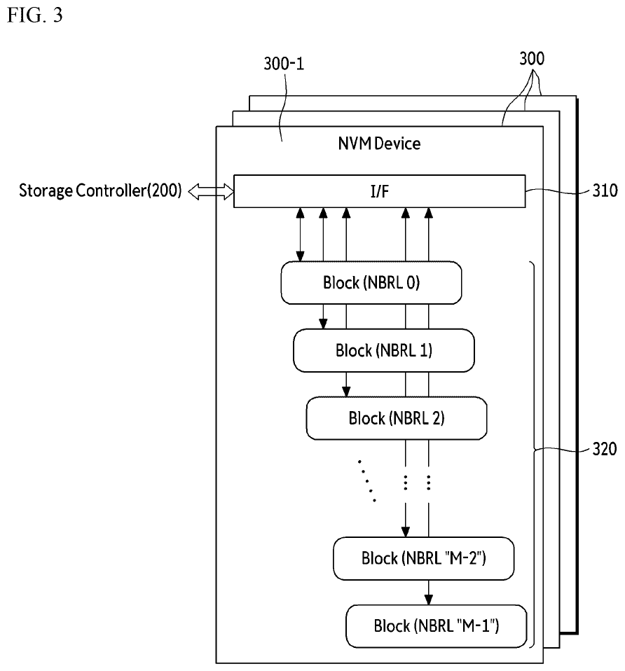

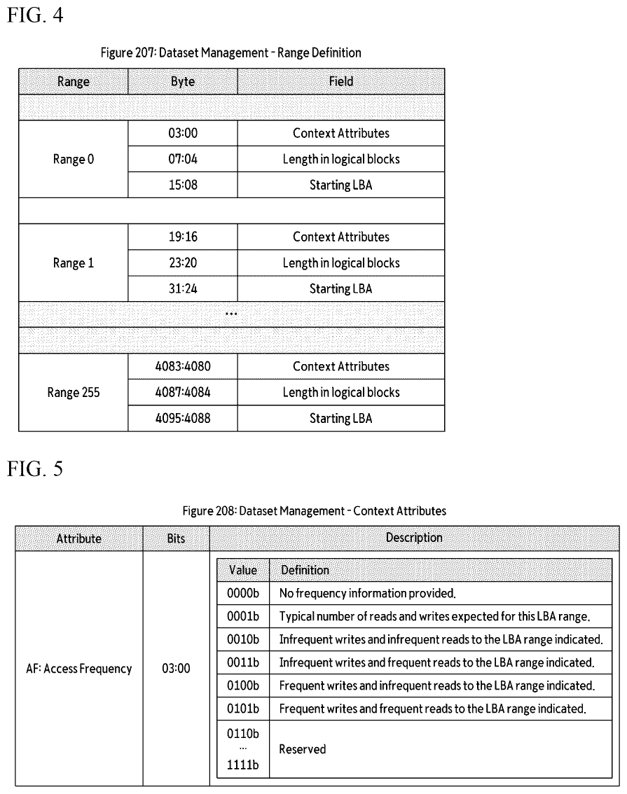

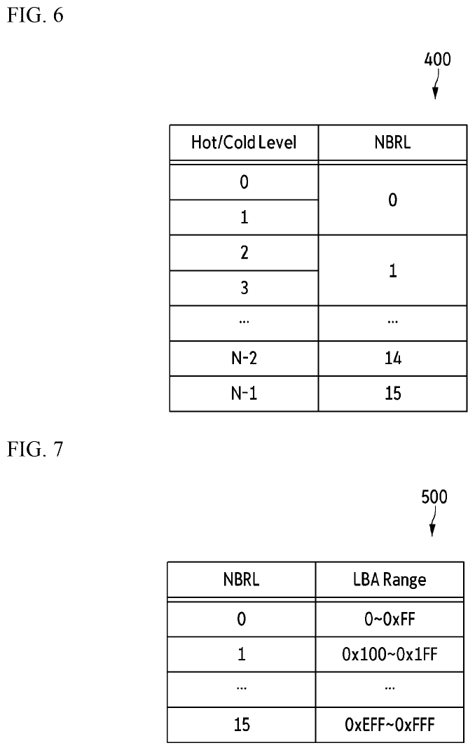

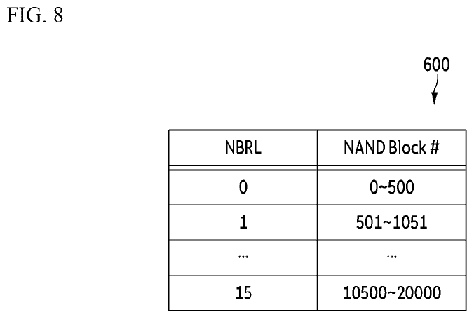

FIG. 2 is a block diagram illustrating an example of a storage controller 200. FIG. 3 is a block diagram illustrating an example of a non-volatile memory device 300. FIG. 4 shows an example of LBA range information included in dataset management information transmitted by a host, and FIG. 5 shows an example of access frequency information included in dataset management information transmitted by a host. FIG. 6 is a mapping table that illustrates an example of mapping between access frequency information and modified reliability level, and FIG. 7 is a mapping table that illustrates an example of mapping between modified reliability level and LBA range information, and FIG. 8 is a mapping table that illustrates an example of mapping between reliability level and block address area of a non-volatile memory device.

In some implementations, when the storage system is turned on, the storage controller 200 receives a plurality of first reliability levels (e.g., as shown in table 600 of FIG. 6, referred to herein as Table 3) mapped to logic block addresses from a non-volatile memory device 140 during the initialization phase, and the storage controller 200 can map and store access frequency information included in the dataset management information received from the host 110 to a plurality of second reliability levels. The storage controller 200 can update the plurality of previously stored first reliability levels to a plurality of second reliability levels based on the LBA range (logic block address range) information of the dataset management information.

When the storage controller 200 subsequently receives an access command and an access address from the host 110, the storage controller 200 can perform an operation corresponding to the access command at the block address of the non-volatile memory device of one of the updated plurality of second reliability levels assigned based on the access address.

For example, the storage controller 200 can include a host interface 210, a memory interface 220, a reliability matching controller 231, a first memory 232 that is a dedicated memory for the reliability matching controller 231, an LBA range matching controller 241, a second memory 242 that is a dedicated memory for the LBA range matching controller 241, and a wear-level matching controller 251 and a wear-level memory 252 that is a dedicated memory for the wear-level matching controller 251. Above each component of the storage controller 200 is connected via a system bus.

The host interface 210 and the memory interface 220 can be implemented as the host interface 131 and the memory interface 132 in FIG. 1.

The host 110 can transmit the dataset management information to the storage controller 200. Referring to FIGS. 4 and 5, the host 110 transmits the dataset management information which includes the logic block address (LBA) area information defined in the NVMe specification (ver. 1.3) and the access frequency information, to the storage controller 200.

Based on the NVMe specification (ver. 1.3), the dataset management information is information for the host 110 to inform the storage device 120 about data characteristics. As one example of the dataset management information can include data characteristics, data usage patterns, data retention characteristic, or unused memory blocks. The storage controller 200 can determine whether to treat the data in the LBA range as hot data or cold data based on the LBA range information of the dataset management information shown in FIG. 4 and the access frequency information shown in FIG. 5. The LBA range information of the dataset management information can be, for example, area information that the entire logic block address of a non-volatile memory device 140 divided into 256 areas. For example, this area information can classify the memory blocks of the non-volatile memory device into single-level cells, multi-level cells, triple-level cells, and quad-level cells.

In some implementations, the CPU 133 in FIG. 1 can include a reliability matching controller 231, an LBA range matching controller 241, and a wear-level matching controller 251. Alternatively, in some implementations, the CPU 133 in FIG. 1 can include the reliability matching controller 231, and the FTL 134 in FIG. 1 can be implemented to include the LBA range matching controller 241 and the wear-level matching controller 251.

The first memory 232, the second memory 242, and the wear-level memory 252 can be implemented as volatile memory in some implementations. For example, it can be implemented as SRAM, DDR SDRAM (Double Data Rate Synchronous DRAM), HBM (High Bandwidth Memory), HMC (Hybrid Memory Cube), and DIMM (Dual In-line Memory Module). The first memory 232, the second memory 242, and the wear-level memory 252 can be initialized whenever the storage system 10 is turned on.

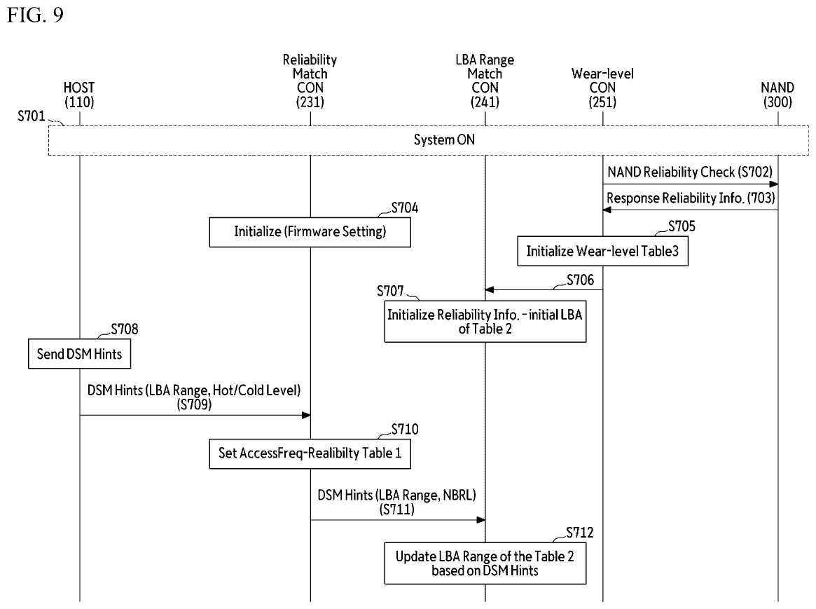

When the reliability matching controller 231 receives the dataset management information (DSM Hint, FIG. 9) from the host 110, the reliability matching controller 231 maps a plurality of reliability levels (NBRL) to each of the plurality of access frequency information included in the dataset management information. For example, if the dataset management information includes M access frequency information, and the storage controller 200 sets it to an N-level reliability level different from M, the reliability matching controller 231 maps the access frequency information and the reliability level information divided into different levels. For example, the reliability level can be information that distinguishes data characteristics based on at least one of the properties of the non-volatile memory device, such as P/E(Program/Erase) cycle, data retention time, BER (Bit Error Rate), read endurance, temperature sensitivity, and durability.

The first memory 232 can store data that represents a mapping between a plurality of reliability levels and the access frequency information. For example, the data stored in the first memory 232 includes a mapping table (e.g., an access-reliability table) between the access frequency information and the reliability level information at different levels. For example, referring to FIG. 6, if there are N access frequency information and 16 reliability levels, some of the access frequency information can be grouped together and matched by one reliability level. For example, a reliability level 0 can be mapped to data of an access frequency information 0 and an access frequency information 1. Depending on the implementation, the access frequency information can be set to hot data with frequent access in ascending order, and the number of tags in the reliability level can be set to ascending or descending order relative to the access frequency information in various implementations.

In this case, the reliability level stored in the first memory 232 can be referred to as the modified reliability level.

When the storage system is initialized, the LBA range matching controller 241 loads a wear-level table between a plurality of LBA range information and the initial reliability level from the wear-level memory 252 and stores the loaded wear-level table first in the second memory 242. Upon receiving dataset management information from the host 110, the initial reliability levels stored based on multiple LBA ranges can be updated to the modified reliability levels mapped according to the access frequency information. For example, as shown in FIG. 7, the second memory 242 can store a plurality of LBA range information as mapping information between the modified reliability level. That is, the LBA range matching controller 241 stores a mapping table 500 that establishes a correlation between the mapping table 400 stored in the first memory 242 and the mapping table 600 stored in the wear-level memory 252.

During the initialization phase, the wear-level matching controller 251 can transmit a reliability level request to the non-volatile memory device 140 and receive multiple initial reliability level information subsequent to transmitting the reliability level request from the non-volatile memory device. That is, the wear-level matching controller 251 can receive an initial reliability level in the multiple initial reliability level information mapped to block addresses within the non-volatile memory device 140. The initial reliability level is also called the first reliability level. The modified reliability level is also called the second reliability level.
The wear-level memory 252 can store mapping information of the logical block addresses for each of the plurality of first reliability levels received from the non-volatile memory device. The mapping information includes a wear-level table that maps a plurality of initial reliability levels in the multiple initial reliability level information received from the non-volatile memory device 140 to logic block addresses. Referring to FIG. 8, for example, the wear-level memory 252 can store a wear-level table 600 that maps k logic block addresses of a plurality of logic blocks in the non-volatile memory device 140 to N first reliability levels (k is a natural number greater than N). For example, the wear-level memory 252 can store a wear-level table 600 that maps 16 initial reliability levels information to multiple logic block ranges in the non-volatile memory device 140.

In some implementations, the wear-level table 600 and the second table 500 can be stored as an address conversion map table of the Flash Translation Layer (FTL).

The non-volatile memory device 300 (see in FIG. 3) can correspond to the non-volatile memory device 140 (see FIG. 1). The non-volatile memory device 300 can include an interface 310 for communicating with the storage controller 200 and a plurality of memory blocks 320.

The non-volatile memory device 300 can independently map reliability levels to each memory block, and the access intensity for each memory block can vary depending on its reliability level. For example, a memory block with a reliability level 0 can be allocated as a location for storing the hot data, which is frequently accessed, while a memory block with a reliability level M-2 can be allocated as a location for storing the cold data, which is rarely accessed.

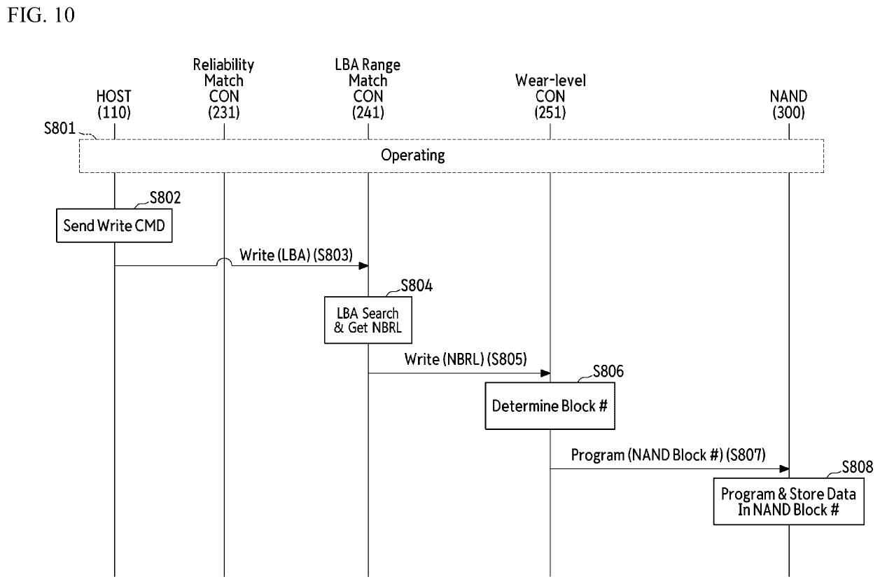

FIGS. 9 and 10 are flow diagrams showing an example of an operation method of a storage system.

Referring to FIG. 9, when the storage system is turned on (S701), an initialization process is performed.

When the wear-level matching controller 251 transmits a reliability level request to the non-volatile memory device 140, the wear-level matching controller 251 receives information regarding multiple logic block ranges in response to the reliability level request (S702, S703). The wear-level matching controller 251 initializes the reliability level information, maps the plurality of logic block range information received from the non-volatile memory device 140 and the initialized reliability level information, and stores as the wear-level table 600, Table 3 (S705).

Meanwhile, the reliability matching controller 231 initializes previously stored reliability information in the first memory 232 (S704). Additionally, the LBA range matching controller 241 deletes the previously stored mapping information in the second memory 242 and stores the wear-level table 600 received via the wear-level matching controller 251 (S706, S707). At this time, the initialization process can be performed by the firmware.

When the storage controller 200 receives the dataset management information DSM Hints from the host 110 (S708), the reliability matching controller 231 maps the access frequency information included in the dataset management information DSM Hints to multiple preset reliability levels. For example, the reliability matching controller 231 maps M access frequency information to N reliability levels and stores it as an access frequency-reliability mapping table 400, Table 1 (S710).

During the initialization process in S707, the LBA range matching controller 241 updates the initial reliability level stored in the second memory 242 to the modified reliability level based on the LBA range information included in the dataset management information DSM Hints and the reliability level information mapped by the reliability matching controller 231 (S712). At this time, the number of the initial reliability level levels set in S705 and the number of the reliability level levels set in S709 are the same.

The reliability level can be a classification of memory blocks into multiple reliability levels based on at least one of properties among P/E cycle, data retention time, BER (Bit Error Rate), read endurance, temperature sensitivity, or durability of the non-volatile memory device 140.

Referring to FIG. 10, while the storage system 10 is in operation after initialization in FIG. 9 (S801), the storage controller 200 can receive an access command and an access address from the host 110.

When the storage controller 200 receives the access command and the access address from the host 110 (S802), the LBA range matching controller 241 checks (or extracts) the reliability level information mapped to the LBA range to which the access address belongs (S804). The wear-level matching controller 251 allocates a logic block range to execute the access command (S806) based on the verified reliability level information (S805), and the non-volatile memory device 300 executes the access command at the allocated block address (S808). For example, if the access command is a data write command, data from the host 110 is written to the allocated block.

As described above, the storage system 10 stores the mapping information in advance by classifying the logical blocks of the non-volatile memory device 140 into reliability levels based on the data characteristics according to the dataset management information. When writing frequently accessed hot data or metadata, the storage system 10 can write the data, according to the mapping information, to a location corresponding to the reliability level based on the data characteristics, as in the non-volatile memory device 300 shown in FIG. 3. Consequently, the reliability of data in the storage device 120 is improved.

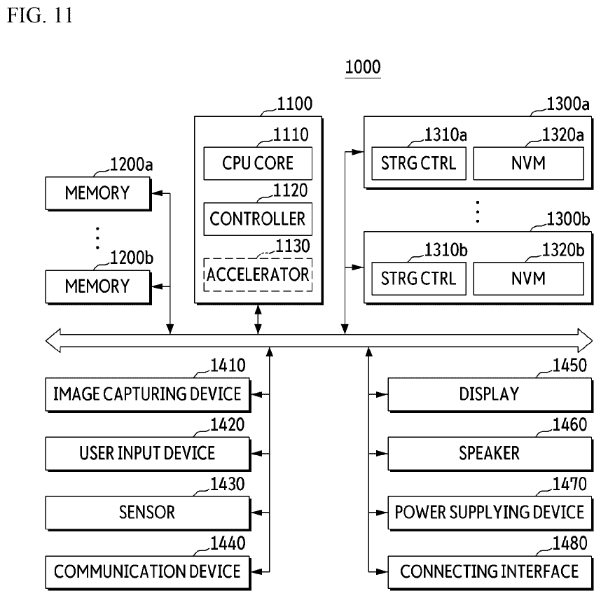

FIG. 11 is a diagram illustrating an example of a system 1000 in which a storage system is applied.

FIG. 11 illustrates a system 1000 to which a storage device is applied. The system 1000 of FIG. 11 can be a mobile system such as a mobile phone, a smart phone, a tablet personal computer (PC), a wearable device, a healthcare device or an Internet of things (IOT) device. However, the system 1000 of FIG. 11 is not necessarily limited to the mobile system, and can be a personal computer, a laptop computer, a server, a media player or an automotive device such as navigator.

Referring to FIG. 11, the system 1000 can include a main processor 1100, memories 1200a and 1200b and storage devices 1300a and 1300b, and can further include one or more of an image capturing device 1410, a user input device 1420, a sensor 1430, a communication device 1440, a display 1450, a speaker 1460, a power supplying device 1470 and a connecting interface 1480.

The main processor 1100 can control the overall operation of the system 1000, more specifically the operation of other elements constituting the system 1000. The main processor 1100 can be implemented as a general purpose processor, a dedicated processor or an application processor.

The main processor 1100 can include one or more CPU cores 1110, and can further include a controller 1120 for controlling the memories 1200a and 1200b and/or the storage devices 1300a and 1300b. In accordance with the implementation, the main processor 1100 can further include an accelerator 1130 that is a dedicated circuit for high-speed data computation such as an artificial intelligence (AI) data computation. The accelerator 1130 can include a graphics processing unit (GPU), a neural processing unit (NPU) and/or a data processing unit (DPU), and can be implemented as a separate chip physically independent of other elements of the main processor 1100.

The memories 1200a and 1200b can be used as main memory devices of the system 1000, and can include a volatile memory such as an SRAM and/or a DRAM but can also include a non-volatile memory such as a flash memory, a PRAM and/or an RRAM. The memories 1200a and 1200b can be implemented in the same package as the main processor 1100.

The storage devices 1300a and 1300b can serve as non-volatile storage devices for storing data regardless of whether a power source is supplied, and can have a storage capacity relatively greater than that of the memories 1200a and 1200b. In some implementations, the storage devices 1300a and 1300b can include storage controllers 1310a and 1310b and non-volatile memories (NVM) 1320a and 1320b for storing data under the control of the storage controllers 1310a and 1310b. The non-volatile memories 1320a and 1320b can include a two-dimensional (2D) or three-dimensional (3D) vertical NAND (V-NAND) flash memory, but can include other types of non-volatile memories such as PRAM and/or RRAM.

The storage devices 1300a and 1300b can be included in the system 1000 in a physically separated state from the main processor 1100, or can be implemented in the same package as the main processor 1100. In addition, the storage devices 1300a and 1300b can be detachably coupled to other elements of the system 1000 through an interface, such as the connecting interface 1480, which will be described later, by having the same form as that of a solid state device (SSD) or a memory card. The storage devices 1300a and 1300b can be devices that comply with a standard protocol such as Universal Flash Storage (UFS), embedded multi-media card (eMMC) or non-volatile memory express (NVMe), but is not necessarily limited thereto.

The storage devices 1300a, 1300b can be implemented as the storage system 10 described in FIG. 1 to FIG. 10. The storage devices 1300a, 1300b can store AI model-related data, where data retention is critical, in memory blocks with a high reliability level. Accordingly, when the system 1000 operates an on-device AI chipset and applications, it can enhance data reliability and performance by storing data in different memory block locations within the storage devices 1300a, 1300b according to the dataset management hints, which classify memory blocks based on reliability levels.

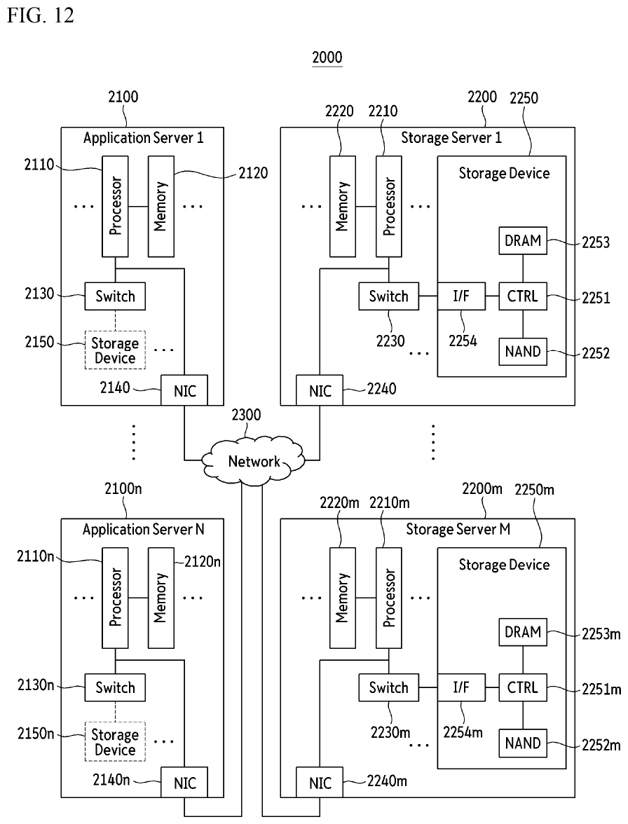

FIG. 12 is a diagram illustrating an example of a data center in which a memory device is applied.

The application server 2100 can access the memory 2120n or storage device 2150n included in another application server 2100n via the network 2300. It can also access the memories 2220-2220m or storage devices 2250-2250m included in storage servers 2200-2200m via the network 2300. Consequently, the application server 2100 can perform various operations on data stored in the application servers 2100-2100n and/or storage servers 2200-2200m. For example, the application server 2100 can execute commands to move or copy data between the application servers 2100-2100n and/or the storage servers 2200-2200m. In such cases, the data can be transferred from the storage devices 2250-2250m of the storage servers 2200-2200m via the memories 2220-2220m of the storage servers 2200-2200m or directly to the memories 2120-3120n of the application servers 2100-2100n. The data transferred through the network 2300 can be encrypted to ensure security and privacy. The storage devices 2150-2150n, 2250-2250m included in the application server 2100 or the storage servers 2200 can be implemented as the storage system 10 described in FIGS. 1 to 10.

The controller 2251 can control the overall operation of the storage device 2250. In some implementations, the controller 2251 can include an SRAM (Static Random Access Memory). The controller 2251 can write data to the NAND flash 2252 in response to a write command, or it can read data from the NAND flash 2252 in response to a read command. For example, when writing data to the NAND flash 2252 in response to a write command, the controller 2251 can refer to a mapping table for reliability level information stored in the DRAM 2253 and write the data to a memory block of the NAND flash 2252 corresponding to the allocated block address.

For example, the write and/or read commands can be provided from the processor 2210 in the storage server 2200, the processor 2210m in another storage server 2200m, or the processors 2110, 2110n in the application servers 2100, 2100n. The DRAM 2253 can temporarily store (buffer) data to be written to or read from the NAND flash 2252. Additionally, the DRAM 2253 can store metadata. Here, the metadata refers to data generated by the controller 2251 to manage user data or NAND flash 2252. For example, the DRAM 2253 can store a mapping table for the reliability level information, which is set based on the dataset management information as described in FIGS. 1 to 10. For example, the DRAM 2253 can include a first table that maps the access frequency information defined in the dataset management information to the modified reliability level, a wear-level table that maps multiple block addresses of the non-volatile memory device 2252-2252m to multiple initial reliability levels, and a second table that maps the initial reliability levels to the modified reliability levels in the first table, based on the LBA range information included in the dataset management information. The storage device 2250 can include an SE (Secure Element) for security or privacy.

What is claimed is:

1. A storage system comprising:
a non-volatile memory device including a plurality of memory blocks; and
a storage controller configured to access the non-volatile memory device by using block addresses of the memory blocks,
wherein the storage controller is configured to
receive, from the non-volatile memory device, a plurality of first reliability levels mapped to logical block addresses of the non-volatile memory device,
receive dataset management information from a host,
map access frequency information included in the dataset management information to a plurality of second reliability levels,
update the plurality of first reliability levels to the plurality of second reliability levels based on logical block address range information of the dataset management information, and
access, based on receiving an access command and an access address from the host, the non-volatile memory device by using a block address corresponding to one of the plurality of second reliability levels that is assigned to a logical block address based on the access address.

2. The storage system of claim 1, wherein the storage controller includes:
a reliability matching controller configured to map the plurality of second reliability levels to the access frequency information included in the dataset management information; and
a first memory configured to store data that represents a mapping between the plurality of second reliability levels and the access frequency information.

3. The storage system of claim 2, wherein the first memory includes:
an access-reliability table configured to map M levels of access frequency information to N levels of second reliability levels,
wherein M and N are different natural numbers equal to or greater than 2.

4. The storage system of claim 1, wherein the storage controller includes:
a wear-level matching controller configured to (i) transmit a reliability level request to the non-volatile memory device and (ii) receive the plurality of first reliability levels subsequent to transmitting the reliability level request from the non-volatile memory device; and
a wear-level memory configured to store mapping information of the logical block addresses for each of the plurality of first reliability levels received from the non-volatile memory device.

5. The storage system of claim 4, wherein the wear-level memory includes:
a wear-level table configured to map k logical block addresses for a plurality of logical blocks in the non-volatile memory device to N levels of the first reliability levels,
wherein k is a natural number greater than N.

6. The storage system of claim 4, wherein the storage controller includes:
a second memory configured to store mapping information that describes a mapping between a plurality of logical block address (LBA) range information and reliability levels; and
an LBA range matching controller configured to
load, from the wear-level memory, first mapping information that describes a mapping between the plurality of LBA range information and the plurality of first reliability levels,
store the first mapping information in the second memory upon initialization of the storage system, and
update, subsequent to receiving the dataset management information, the plurality of first reliability levels to the plurality of second reliability levels based on the plurality of LBA range information.

7. The storage controller of claim 1, wherein the second reliability levels classify the memory blocks of the non-volatile memory device into single-level cells, multi-level cells, triple-level cells, and quad-level cells.

8. A storage controller comprising:
a host interface configured to receive dataset management information including access frequency information and logical block address (LBA) range information from a host;
a memory interface configured to access a non-volatile memory device by using block addresses;
a memory configured to store mapping information that describes a mapping between (i) a plurality of reliability levels and (ii) a plurality of access frequency information or address information of the non-volatile memory device; and
a control processing unit(CPU) configured to access the non-volatile memory device based on a command from the host,
wherein the CPU is configured to
receive an access command and an access address from the host,
select a reliability level associated with a respective LBA range information to which the access address belongs among a plurality of LBA range information,
allocate, to the access command, a block address of the non-volatile memory device corresponding to the selected reliability level, and
control an execution of the access command at the allocated block address of the non-volatile memory device.

9. The storage controller of claim 8, wherein the memory comprises:
a first table including M access frequency information that are defined in the dataset management information and that are mapped to N levels of modified reliability levels;
a wear-level table including a plurality of block addresses of the non-volatile memory device that are mapped to N levels of initial reliability levels; and
a second table including the initial reliability levels that are mapped to the modified reliability levels of the first table based on the LBA range information included in the dataset management information,
wherein M and N are different values and are natural numbers equal to or greater than 2.

10. The storage controller of claim 9, wherein the non-volatile memory device includes a plurality of memory blocks, each memory block being configured to have a single initial reliability level of N levels of the initial reliability levels that is mapped to a block address of the corresponding memory block.

11. The storage controller of claim 9, wherein the wear-level table and the second table are configured to be stored as address conversion map tables of a flash translation layer (FTL).

12. The storage controller of claim 9, wherein the CPU is configured to update mapping information that describes a mapping between the access frequency information and the modified reliability level in the first table, each time dataset management information is received from the host.

13. The storage controller of claim 12, wherein the CPU is configured to update mapping information that describes a mapping between the LBA range information and the modified reliability level in the second table, each time the dataset management information is received from the host.

14. The storage controller of claim 8, wherein the non-volatile memory device includes a plurality of memory blocks, and
wherein the LBA range information is configured to classify the memory blocks into single-level cells, multi-level cells, triple-level cells, and quad-level cells.

15. A method of operating a storage controller comprises:
receiving reliability information for each memory block from a non-volatile memory device;
receiving dataset management information including access frequency information and logical block address (LBA) range information from a host;
configuring a mapping table for reliability level information that is mapped to the access frequency information, the LBA range information, and the reliability information, respectively;
receiving an access command including an access address from the host;
allocating a memory block of the non-volatile memory device based on the reliability level information that is mapped to the LBA range information corresponding to the access address; and
accessing the allocated memory block.

16. The method of operating a storage controller of claim 15, wherein the storage controller is configured to update the mapping table for the reliability level information, each time the dataset management information is received.

17. The method of operating a storage controller of claim 15, wherein the mapping table includes:
a first table including M access frequency information that is defined in the dataset management information and that is mapped to N levels of modified reliability levels;
a wear-leveling table including a plurality of block addresses of the non-volatile memory device that are mapped to N levels of initial reliability levels; and
a second table including the initial reliability levels that are mapped to the modified reliability levels of the first table based on the LBA range information included in the dataset management information,
wherein M and N are natural numbers equal to or greater than 2 and have different values.

18. The method of operating a storage controller of claim 17, wherein the reliability information for each memory block includes N levels of initial reliability levels that are mapped to each corresponding memory block of the non-volatile memory device.

19. The method of operating a storage controller of claim 15, wherein the mapping table is initialized each time a storage system is powered on.

20. The method of operating a storage controller of claim 17, wherein the modified reliability levels classify memory blocks into N reliability levels based on at least one of a Program/Erase(P/E) cycle, a data retention time, a bit error rate (BER), a read endurance, a temperature sensitivity, or a durability of the non-volatile memory device.
